(19) United States
(12) Patent Application Publication
(10) Pub. No.: US 2008/0296957 A1
(43) Pub. Date: Dec. 4, 2008

(54) Retractable footrest

(76) Inventor: Robert Clough, Canyon Country, CA (US)

Correspondence Address: JAMES E. BRUNTON, ESQ., P. O. BOX 29000, GLENDALE, CA, 91209, US

(21) Appl. No.: 12/221,378

(22) Filed: Aug. 1, 2008

Related U.S. Application Data
(63) Continuation-in-part of application No. 11/789,844, filed on Apr. 25, 2007.

(51) Int. Cl. B60N 2/44

(52) U.S. Cl. 297/423.15

(57) ABSTRACT

A vehicle seat that embodies a foot support assembly that is movable from a stowed position proximate the seat back to a deployed position wherein the assembly extends rearwardly of the seat. The foot support assembly of the vehicle seat includes a sub-assembly that comprises a pair of side-support members that support a footrest, the sub-assembly being positioned so as to automatically pivot downwardly as the foot support assembly is moved into its deployed position. The footrest is pivotally connected to the pair of side-support members for movement from a stowed position between the side-support members to a deployed position wherein it extends outwardly from the side-support members.

This is a Continuation-In-Part of co-pending U.S. Ser. No. 11/789,844 filed Apr. 25, 2007.

### BACKGROUND OF THE INVENTION

### Field of the Invention

The present invention relates generally to seating. More particularly, the invention concerns a vehicle seat embodying a novel, retractable foot support assembly.

### SUMMARY OF THE INVENTION

It is an object of the present invention to provide a novel vehicle seat that embodies a foot support assembly that is movable from a stowed position proximate the seat back to a deployed position wherein the assembly extends rearwardly of the seat.

Another object of the invention is to provide a vehicle seat as described in the preceding paragraph that includes a novel connector means for connecting the foot support assembly to the vehicle seat that yieldably resists movement of the foot support assembly toward the deployed position.

Another object of the invention is to provide a vehicle seat of the aforementioned character in which the foot support assembly includes a sub-assembly that comprises a pair of side-support members that support a footrest, the sub-assembly being positioned so as to automatically pivot downwardly as the foot support assembly is moved into its deployed position.

Another object of the invention is to provide a vehicle seat of the character described in the preceding paragraph in which the footrest is pivotally connected to the pair of side-support members for movement from a stowed position between the side-support members to a deployed position wherein it extends outwardly from the side-support members.

Another object of the invention is to provide a vehicle seat of the class described that is of a simple construction that can be easily and inexpensively manufactured.

Another object of the invention is to provide a vehicle seat as described in the preceding paragraphs that is easy to install, requires little maintenance and one that is highly reliable in operation.

### BRIEF DESCRIPTION OF THE DRAWINGS

FIG. 1 is a fragmentary, generally perspective, rear view of an aircraft passenger seat showing the footrest assembly of the invention interconnected with the passenger seat and moved into a deployed position.

FIG. 2 is a generally perspective, partially exploded view of the form of the footrest assembly of the invention illustrated in FIG. 1.

FIG. 3 is a greatly enlarged, generally perspective, partially exploded view of the left hand portion of the footrest assembly shown in FIG. 2.

FIG. 4 is an enlarged, cross-sectional view taken along lines 4-4 of FIG. 1.

FIG. 5 is an enlarged, cross-sectional view taken along lines 5-5 of FIG. 4.

FIG. 6 is an enlarged, cross-sectional view taken along lines 6-6 of FIG. 4.

FIG. 7 is an enlarged, cross-sectional view, similar to FIG. 4, but showing the footrest assembly of the invention moved into a stowed position.

FIG. 8 is an enlarged, cross-sectional view taken along lines 8-8 of FIG. 4.

### DESCRIPTION OF THE INVENTION

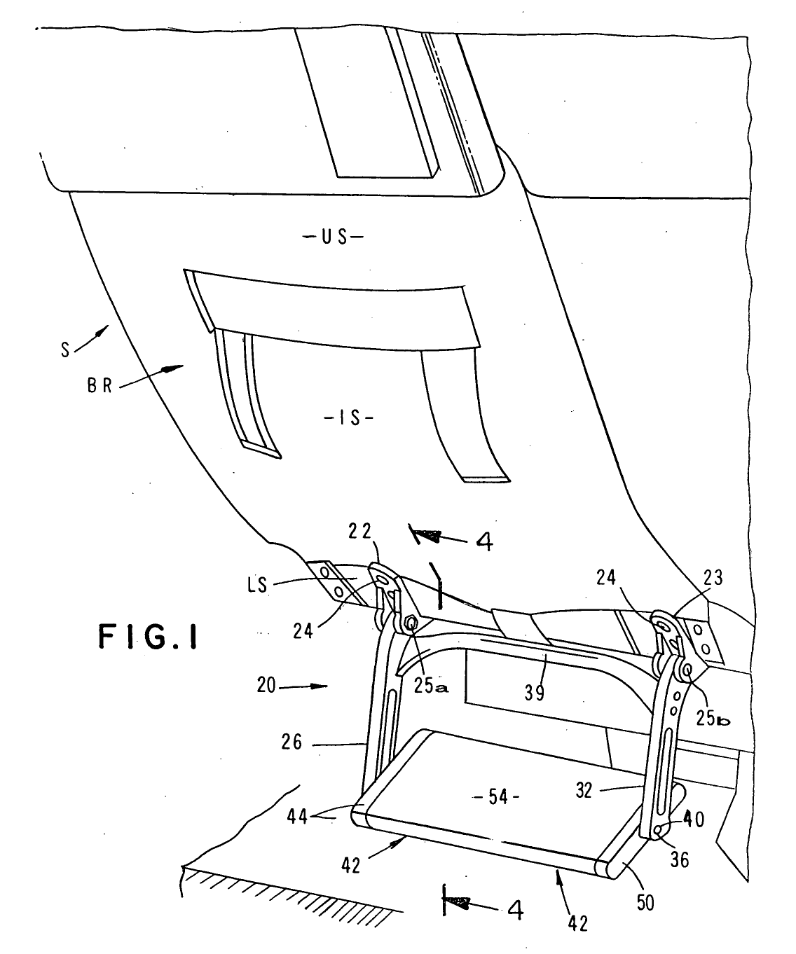

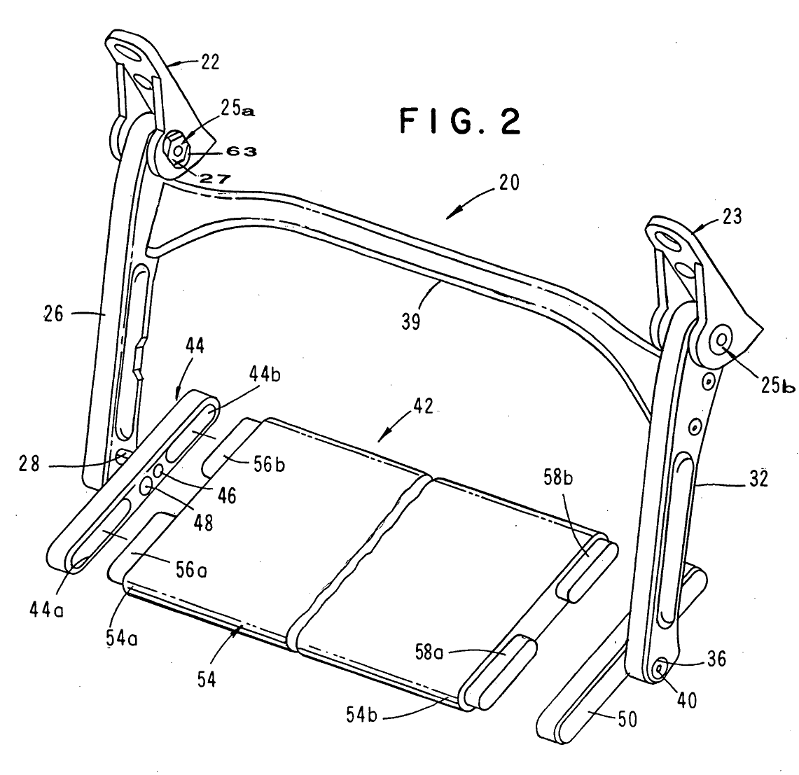

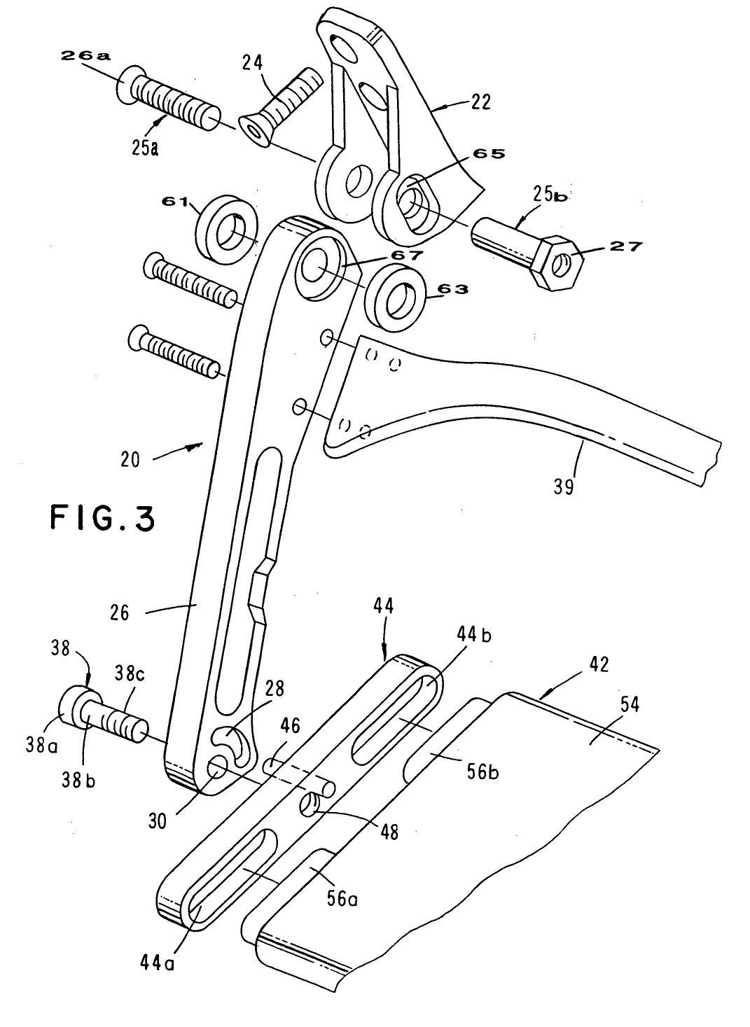

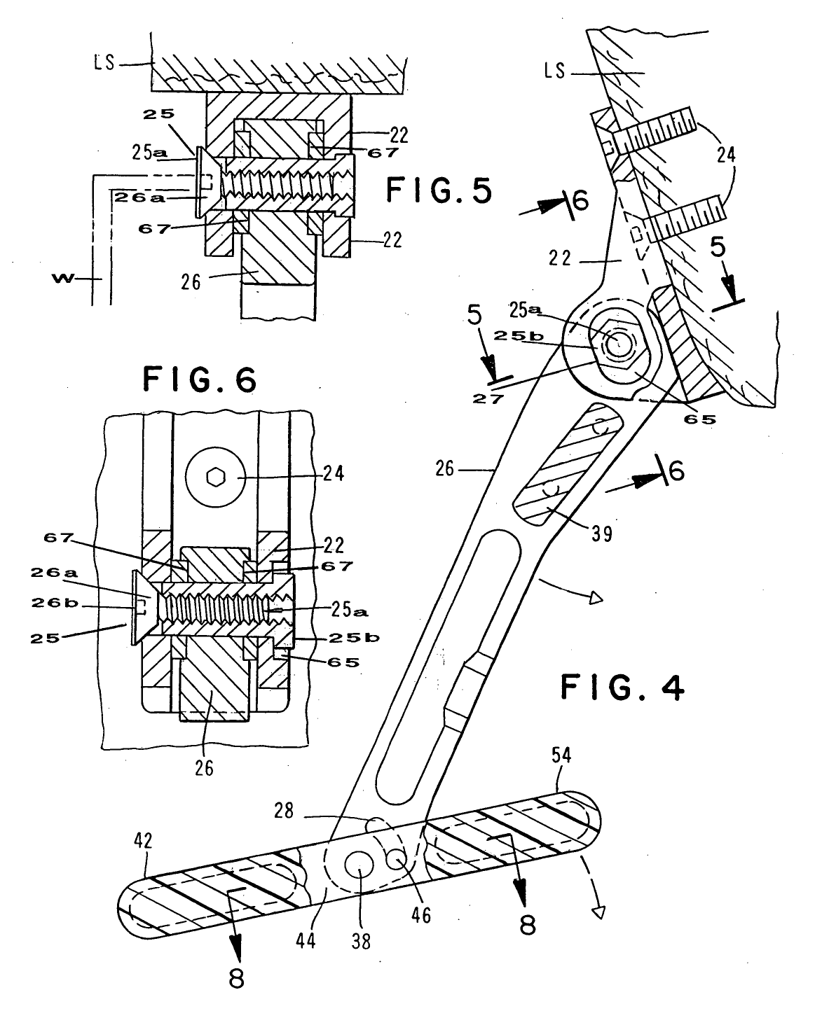

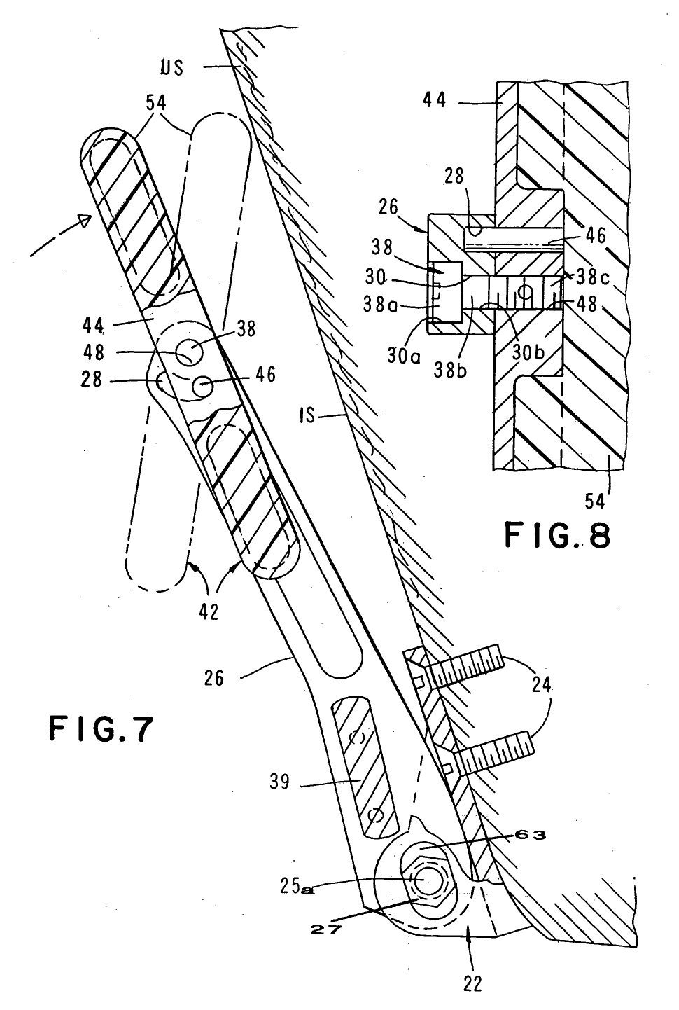

Referring to the drawings and particularly to FIGS. 1 through 3, one form of the footrest of the invention is there shown and generally designated by the numeral 20. The footrest of this form of the invention is designed to be used in combination with an aircraft passenger seat “S” that includes a backrest “BR” having a rear upper surface “US”, a rear lower surface “LS” and a rear intermediate surface “IS”. As best seen in FIG. 1, the footrest here comprises first and second spaced-apart connector brackets 22 and 23 that are connected to the rear lower surface “LS” of the passenger seat “S” by conventional threaded connectors 24 (FIGS. 3 and 4). Pivotally connected to first connector bracket 22 by means of a conventional two-part connector assembly 25 is a first side member 26 that is movable relative thereto between a first lowered position shown in FIG. 1 and a second upraised position shown in FIG. 7. For a purpose presently to be described, first side member 26 is provided with an arcuate-groove 28 and a through-bore 30 having an enlarged diameter portion 30a and a reduced diameter portion 30b (FIG. 8). Pivotally connected to second connector bracket 23 is a second side member 32 that is movable along with first side member 26 between a first lowered position and a second upraised position. Second side member 32 is also provided with a through-bore 36 that is of similar configuration to through-bore 30. A cross brace 39 is connected to and spans members 26 and 32 (FIGS. 1 and 2).

Also forming a part of the footrest of the present invention are first and second pivot pins 38 and 40. Pivot pin 38 has a head portion 38a, a shank portion 38b and a threaded end portion 38c. As shown in FIGS. 3 and 8, pivot pin 38 is receivable within the through-bore 30 of the first side member 26, so that the head portion 38a resides within enlarged diameter portion 30a and the shank portion 38b resides within reduced diameter portion 30b. Second pivot pin 40, which is of similar construction to pivot pin 38, is receivable within the through-bore 36 of the second side member 32 in the manner indicated in FIG. 2.

Pivotally connected to the first and second spaced-apart side members 26 and 32 for pivotal movement relative thereto between a first stowed position shown in FIG. 7 and a second deployed position shown in FIGS. 1 and 4 is a foot support assembly generally designated by the numeral 42. As best seen in FIG. 2 of the drawings, foot support assembly 42 comprises a first connector member 44 having an outwardly extending stop pin 46 that is closely receivable within the arcuate-groove 28 formed in first side member 26 (See FIG. 3). Stop pin 46 and arcuate-groove 28 form a part of the stop means of the invention for controlling the extent of pivotal movement of the foot assembly 42 relative to the first and second side members 26 and 32. Connector member 44 also has a generally centrally disposed, threaded-bore 48 for threadably receiving the threaded end portion 38c of first pivot pin 38 (FIG. 3).

Foot support assembly 42 also comprises a second connector member 50 having a generally centrally disposed, threaded-bore for threadably receiving the threaded end portion of second pivot pin 40. As best seen in FIG. 2, first connector member 44 is provided with a pair of spaced-apart, elongated first slots 44a and 44b. Second connector member 50 is also provided with a similar pair of spaced-apart, elongated second slots (not shown).

Connected to and spanning first and second spaced-apart connector members 44 and 50 is a generally planar foot support 54. Foot support 54 has a first end 54a provided with a pair of spaced-apart, elongated first protuberances 56a and 56b that are receivable within slots 44a and 44b (FIG. 2). Similarly, planar foot support 54 has a second end 54b provided with a pair of spaced-apart, elongated second protuberances 58a and 58b receivable within the pair of spaced-apart, elongated second slots formed in the second connector member 50. With this construction, the planar foot support can be secured to connector members 44 and 50 in the manner shown in FIG. 1 to form a rigid support for the feet of the passengers.

Forming an important aspect of the present invention is a pair of connector assemblies of novel construction that function to connect side members 26 and 32 to connector brackets 22 and 23. As shown in FIGS. 2, 3 and 5 of the drawings, each connector assembly of the pair of connector assemblies comprises an internally threaded member 25b having a generally hexagonally configured head portion 27 that is closely receivable within generally oval-shaped, locking cavities 65 formed in the pair of transversely spaced-apart connector brackets 22 and 23 (see for example FIGS. 3, 4 and 6).

Each connector assembly of the pair of connector assemblies also comprises an externally threaded member 26a that is threadably connected to internally threaded member 25b in the manner indicated in FIGS. 5 and 6. Each connector assembly of the pair of connector assemblies further comprises conventional friction washers, 61 and 63, the purpose of which will presently be described. As illustrated in the drawings, each of the connector arms 26 and 32 is provided with spaced-apart, generally circular shaped, washer receiving cavities 67 that closely receive the friction washers 61 and 63 (see for example FIG. 3).

It is important to note that each of the externally threaded members 25a of each of the connector assemblies has a tapered head 26a that is provided with an Allen wrench “W” (FIG. 5) receiving socket 26b (FIG. 6).

With the construction described in the preceding paragraphs, when the connector assemblies are assembled in the manner shown in FIGS. 5 and 6 of the drawings with the hexagonal heads 27 of the internally threaded members locked against rotation within oval-shaped opening 63, externally threaded member 25a can be readily tightened relative to internally threaded member 25b through the use of the Allen wrench “W” (FIG. 5). In this way an appropriate amount of pressure can be exerted against friction washers 67, which circumscribe externally threaded member 25a, so as to thereby controllably adjust the force necessary to move the arms 26 and 32 from the stowed position shown in FIG. 7 to the deployed position shown in FIG. 4. Because of the novel construction of the connector assemblies and because hexagonal heads 27 of the internally threaded members are securely located within opening 63, once the unit is tightened, it cannot loosen due to continued movement of the arms 26 and 32 from the stowed position to the deployed position. This important feature of the invention comprises a substantial improvement over prior art devices of similar construction and function.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. In combination with a seat, including a seat portion and a backrest having a rear upper surface, a rear lower surface and a rear intermediate surface, a footrest assembly comprising:
(a) a pair of transversely spaced-apart connector brackets connected to said rear lower surface of said backrest, each said connector bracket having a locking cavity formed therein;
(b) a pair of side members pivotally connected to said connector brackets for movement relative thereto between a first lowered position and a second upraised position;
(c) a pair of connector assemblies connecting said pair of side members to said pair of connector brackets, each said connector assembly of said pair of connector assemblies comprising:
(i) an internally threaded member having a head portion closely receivable within said locking cavities formed in said pair of transversely spaced-apart connector brackets; and
(ii) an externally threaded member connected to said internally threaded member; and
(d) a foot support assembly pivotally connected to each of said spaced-apart side members.

2. The combination as defined in claim 1 in which each of said side members is provided with a washer receiving cavity and in which each said connector assembly of said pair of connector assemblies further comprises a pair of friction washers received within said washer receiving cavities.

3. The combination as defined in claim 2 in which each of said externally threaded members of each said connector assembly of said pair of connector assemblies has a tapered head provided with an Allen wrench receiving socket.

4. The combination as defined in claim 2 in which said foot support assembly comprises:
(a) a pair of transversely spaced-apart connector members; and
(b) a generally planar foot support connected to and spanning said spaced-apart connector members, said pair of transversely spaced-apart connector members being pivotally movable relative said spaced-apart side members between a first stowed position wherein said connector members are generally parallel with said spaced-apart side members to a second deployed position wherein said connector members are angularly inclined relative to said spaced-apart side members.

5. The combination as defined in claim 4 in which each of said spaced-apart side members is provided with an arcuate-groove and in which each of said spaced-apart connector members is provided with an outwardly extending pin that is closely receivable within said arcuate groove.

6. The combination as defined in claim 5 in which said foot support assembly further comprises a pair of pivot pins, each having a shank portion and a threaded end portion and in which each of said spaced-apart connector members is provided with a generally centrally disposed threaded-bore for threadably receiving said threaded end portion of a selected one of said pair of pivot pins.

7. The combination as defined in claim 6 in which each of said spaced-apart side members is provided with a through-bore for receiving a selected one of said pair of pivot pins.

8. In combination with a seat, including a seat portion and a backrest having a rear upper surface, a rear lower surface and a rear intermediate surface, a footrest assembly comprising:
(a) a pair of transversely spaced-apart connector brackets connected to said rear lower surface of said backrest, each said connector bracket having a generally oval-shaped cavity formed therein;
(b) a pair of side members pivotally connected to said connector brackets for movement relative thereto between a first lowered position and a second upraised position, each of said side members being provided with a generally circular shaped cavity;
(c) a pair of connector assemblies connecting said pair of side members to said pair of connector brackets, each said connector assembly of said pair of connector assemblies comprising:
(i) an internally threaded member, said internally threaded member having a hexagonal shaped head portion closely receivable within said generally oval-shaped cavities formed in said pair of transversely spaced-apart connector brackets;
(ii) an externally threaded member connected to said internally threaded member, said externally threaded member having a tapered head provided with an Allen wrench receiving socket; and
(iii) a pair of friction washers received within said generally circular shaped cavities formed in said pair of side members; and
(d) a foot support assembly pivotally connected to each of said spaced-apart side members.

9. The combination as defined in claim 8 in which said foot support assembly comprises:
(a) a pair of transversely spaced-apart connector members; and
(b) a generally planar foot support connected to and spanning said spaced-apart connector members, said pair of transversely spaced-apart connector members being pivotally movable relative said spaced-apart side members between a first stowed position wherein said connector members are generally parallel with said spaced-apart side members to a second deployed position wherein said connector members are angularly inclined relative to said spaced-apart side members.

10. In combination with a seat, including a seat portion and a backrest having a rear upper surface, a rear lower surface and a rear intermediate surface, a footrest assembly comprising:
(a) a pair of transversely spaced-apart connector brackets connected to said rear lower surface of said backrest, each said connector bracket having a generally oval-shaped cavity formed therein;
(b) a pair of side members pivotally connected to said connector brackets for movement relative thereto between a first lowered position and a second upraised position, each of said side members being provided with a generally circular shaped cavity;
(c) a pair of connector assemblies connecting said pair of side members to said pair of connector brackets, each said connector assembly of said pair of connector assemblies comprising:
(i) an internally threaded member, said internally threaded member having a hexagonal shaped head portion closely receivable within said generally oval-shaped cavities formed in said pair of transversely spaced-apart connector brackets;
(ii) an externally threaded member connected to said internally threaded member, said externally threaded member having a tapered head provided with an allen wrench receiving socket; and
(iii) a pair of friction washers received within said generally circular shaped cavities formed in said pair of side members; and
(d) a foot support assembly pivotally connected to each of said spaced-apart side members, said foot support assembly comprising:
(i) a pair of transversely spaced-apart connector members; and
(ii) a generally planar foot support connected to and spanning said spaced-apart connector members, said pair of transversely spaced-apart connector members being pivotally movable relative said spaced-apart side members between a first stowed position wherein said connector members are generally parallel with said spaced-apart side members to a second deployed position wherein said connector members are angularly inclined relative to said spaced-apart side members.
